(19) United States
(12) Patent Application Publication
(10) Pub. No.: US 2013/0019195 A1
(43) Pub. Date: Jan. 17, 2013

(54) AGGREGATING MULTIPLE INFORMATION SOURCES (DASHBOARD4LIFE)

(71) Applicant: Adam Gates, Huntersville, NC (US)

(72) Inventor: Adam Gates, Huntersville, NC (US)

(73) Assignee: Oracle International Corporation, Redwood Shores, CA (US)

(21) Appl. No.: 13/181,294

(22) Filed: Jul. 12, 2011

(51) Int. Cl. G06F 3/048

(52) U.S. Cl. 715/771

(57) ABSTRACT

A system and method for facilitating accessing data. An example method includes showing a first portion of a display screen, which is adapted to display digital content; illustrating one or more user interface gauges via a second portion of the display screen; and providing a first user option to adjust content displayed via the one or more user interface gauges. In a specific embodiment, the method further includes providing a second user option to control or specify movement of the one or more gauges across the display screen, and providing a third user option to specify a scrolling motion of one or more gauges along a predetermined path.

### BACKGROUND

The present application relates to software and more specifically to systems, user interfaces, and methods for accessing, displaying, and monitoring data.

Systems and methods for displaying and monitoring data are employed in various demanding applications, including web browsers, Enterprise Resource Planning (ERP) systems and software, websites and accompanying widgets, software for monitoring industrial processes and sensor networks, and so on.

Systems and methods for effectively accessing and displaying data are particularly important in web browser applications, where browsers are often employed to access various websites and Internet-based accounts, including social networking accounts (e.g., Facebook, Twitter, etc.), bank and credit card accounts, shopping accounts, and so on. However, accessing data from such sites often requires a user to browse to each website separately; enter login information; and then navigate various user interface screens within a website to access desired data.

To overcome certain inefficiencies in accessing Internet-based information, tabbed browsing is often employed. A user may employ a tabbed browser to open multiple websites, which may appear in various user interface tabs of the tabbed browser. However, the need remains to separately log in to each account and perform various browsing functions to access desired information.

To overcome the need to remember multiple passwords and login information for each website, software for storing and selectively retrieving login information for each account or website may be employed. However, users must still perform various browsing steps, also called navigations, to access desired information.

To reduce the need to browse to multiple websites to access desired information, software for aggregating data from multiple social networking websites has been developed. This so-called social network aggregation software may facilitate accessing data from multiple social-networking websites. However, such software is typically limited to aggregating data from a set of predetermined websites.

### SUMMARY

An example method facilitates accessing data via a browser. The example method includes showing a first portion of a display screen for displaying digital content; illustrating one or more user interface gauges via a second portion of the display screen; providing a first user option to adjust content displayed via the one or more user interface gauges; and providing a second user option to control or specify movement of the one or more gauges across the display screen.

In an example specific embodiment, movement of the one or more gauges includes a scrolling motion along a predetermined path. A user interface control enables a user to specify a path along which gauges follow when moving across the display screen. One or more additional user interface controls enable a user to specify where a scrolling sequence of gauges terminates, beyond where gauges of the sequence of gauges disappear from the display screen for a predetermined time interval and then reappear at a start of the scrolling sequence of gauges after the predetermined time interval. One or more additional user interface controls enable a user to adjust a frequency at which a particular gauge appears in the display screen. Additional user interface controls may enable a user to further configure gauges, such as by adjusting a size, shape, and color of each gauge to appear in the display screen, and so on.

The specific example embodiment further includes providing a third user option to add one or more gauges to the display screen and to select or adjust content to be displayed therein. The content may include, for example, streaming video data from a user selected website, a measurement of a metric derived from a user specified website, etc. The metric may include, for example, a bank account balance, a credit card balance, an indication of a number of messages received by a user via an account of the user, etc.

A fourth user option enables a user to install and/or activate a user interface skin that adjusts the display screen in accordance with computer code associated with the user interface skin. The user interface skin may include one or more gauges with one or more predefined characteristics. Example predefined characteristics include gauge shapes, sizes, and hyperlinks characterizing each gauge.

A fifth user option enables a user to share a gauge with another user of the example method. One or more user interface controls may facilitate posting a shared gauge to a predetermined website, such as Facebook or Twitter, or otherwise sharing gauge and/or dashboard configurations and content. A sixth user option enables a user to specify content or a link thereto to be pulled to a particular gauge at a predetermined time or to be pushed to a primary browser display screen, i.e., the first portion of the display screen, at a predetermined time.

The second portion of the display screen may be represented by regions of the gauges themselves. The gauges may be displayed in proximity to or overlaid relative to the first portion of the display screen. A web browser may be employed to illustrate the display screen. The gauges may act as special scrolling multi-functional bookmarks, as opposed to conventional link-only bookmarks. A gauge may be converted to a conventional bookmark and vice versa via one or more user options provided via the web browser in accordance with the present example method.

Hence, certain embodiments discussed herein may provide tools for network users to view, search for, and monitor data via a network, such as the Internet or intranet. Options may be provided for creating instances of preexisting dashboards (i.e., the display screen and accompanying gauges) on virtually any network-connected computer, whether an enterprise system, personal computer, or mobile computing device. Furthermore, use of scrolling or moving gauges in combination with use of appearance-frequency specifications may facilitate maximizing available screen viewing real estate in accordance with user priorities and preferences. In addition, use of dashboards as discussed herein may facilitate rapidly accessing desired content, multi-tasking, improving situational awareness to facilitate informed decision making, managing tasks, and so on.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example embodiment of a dashboard browsing system implemented via server-side architecture.

FIG. 2 is a diagram illustrating a second example embodiment of a dashboard browsing system implemented via a client-side architecture.

FIG. 3 is a diagram illustrating a first example user interface display screen, which may be generated by the systems of FIGS. 1 and/or 2, whereby a user can configure one or more translating gauges.

FIG. 4 is a diagram illustrating a second example user interface display screen after an example skin has been applied to the user interface display screen of FIG. 3.

FIG. 5 is a diagram illustrating a third example user interface display screen, which may be accessible via the example user interface display screens of FIGS. 2 and 3.

FIG. 6 is a flow diagram illustrating a first example process, which may be implemented via the systems of FIGS. 1 and/or 2, for adding a gauge to a user interface display screen of a browser.

FIG. 7 is a flow diagram illustrating a second example process, which may be implemented via the systems of FIGS. 1 and/or 2, for adding a gauge to a user interface display screen of a browser.

FIG. 8 is a flow diagram of a first example method adapted for use with the embodiments of FIGS. 1-5.

FIG. 9 is a flow diagram of a second example method adapted for use with the embodiments of FIGS. 1-5.

### DETAILED DESCRIPTION OF EMBODIMENTS

Although the description has been described with respect to particular embodiments thereof, these particular embodiments are merely illustrative, and not restrictive.

For example, while various embodiments are discussed herein with respect to systems and methods for facilitating displaying selected content via a web browser screen with configurable gauges and a virtual windshield displayed therein, embodiments are not limited thereto. For example, use of gauges, as discussed herein, for selectively delivering content to a user interface, may be applicable to various software programs and content, such as Enterprise Resource Planning (ERP) systems and content; not just Internet-based content.

Furthermore, while various embodiments disclosed herein employ graphical depictions of gauges, which may be implemented via widgets, embodiments are not limited to the use of graphical features that resemble gauges. For example, use of text (as opposed to graphical representations of gauges), such as scrolling bookmarks that can scroll through a screen based on a user-determined path, and/or that otherwise exhibit certain features attributable to gauges discussed herein (e.g., may be shared with others), may fall within the scope of the present teachings.

For the purposes of the present discussion, a gauge may be any graphical depiction, whereby contents of the graphical depiction may selectively change according to changing content or predetermined parameters or metrics associated with the graphical depiction. A graphical representation of a bookmark may be considered a type of gauge. In this case, content associated with the graphical representation represents a link associated with the graphical depiction. An image map may be considered to be a type of gauge.

A dynamic gauge may be any gauge wherein the graphical depiction itself (e.g., gauge size, shape, color, etc.) changes in accordance with changes in underlying data associated with or otherwise linked to the gauge. A shared gauge may be any gauge that has been made available by a user for copying or displaying, including copying or displaying contents thereof, by other persons or computers.

For clarity, certain well-known components, such as hard drives, processors, operating systems, power supplies, Internet Service Providers (ISPs) and so on, have been omitted from the figures. However, those skilled in the art with access to the present teachings will know which components to implement and how to implement them to meet the needs of a given implementation.

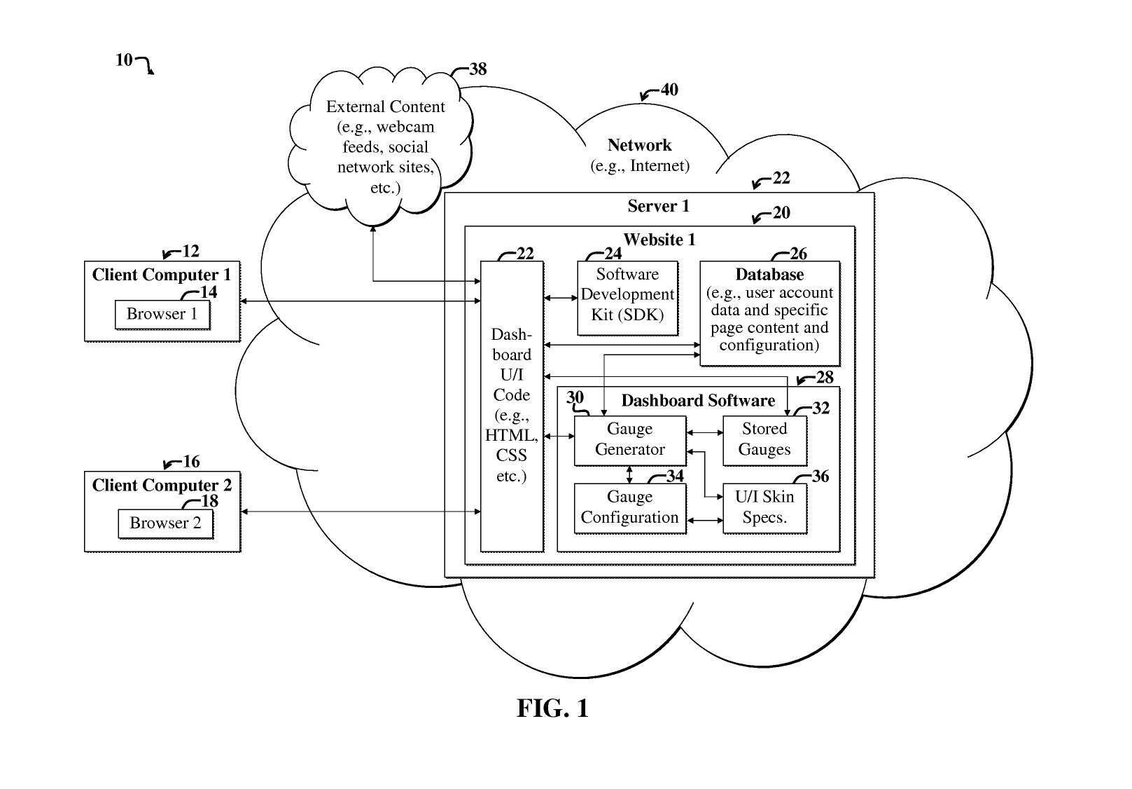

FIG. 1 is a diagram illustrating a first example embodiment of a dashboard browsing system 10 implemented via server-side architecture. The example system 10 includes a server 22 as part of or otherwise coupled to a network 40, such as an intranet or the Internet. The server 22, which hosts a website 20, is accessible via a first client computer 12 and accompanying first browser 14, and a second client computer 16 and accompanying second browser 18.

The website 20, called the dashboard website herein, includes user interface code 22 for rendering display screens to be illustrated via the browsers 14, 18. The user interface code 22 may be implemented via one or more markup languages, such as HyperText Markup Language (HTML), Cascading Style Sheets (CSS), eXtensible Markup Language (XML), and so on.

The website 20 further includes a server-side Software Development Kit (SDK) 24, a database 26, and dashboard software 28, which may communicate with the user interface code 22. Note that the SDK 24, database 26, and dashboard software 28 are implemented server-side, i.e., remotely executable on the server 22 via the client computers 12, 16.

The example server-side dashboard software 28 includes a gauge generator 30 in communication with the dashboard user interface code 22. A gauge repository 32 (stored gauges) stores code and data for executing certain gauges. A gauge configuration module 34 facilitates implementing functionality for enabling users to configure gauges. A user interface skin specification module 36 (U/I skin specifications) provides functionality for facilitating user specification and storage of dashboard skins.

The gauge generator 30 may communicate with the gauge configuration module 34, gauge repository 32, the U/I skin specifications 36, and the database 26. The gauge configuration module 34 may also access the U/I skin specification module 36.

Note that the dashboard user interface code 22 may include code for accessing external content 38, i.e., content hosted on other servers coupled to the network 40. Examples of external content include webcam feeds, social network websites, bank websites, credit card websites, and so on.

In an example operative scenario, a user employs the first client computer 12 to access the website 20 via the Internet 40. The dashboard code 22 facilitates rendering a dashboard webpage, which is displayed on the first browser 14. The user then supplies login information, such as user name and password to access the user's dashboard account. Information about the user's dashboard configuration is stored with user account information via the database 26. The dashboard user interface code 22 facilitates retrieving user-specific information and rendering a user-specific webpage containing user-specific information based on the user supplied dashboard account information. The dashboard user interface code 22 may forward gauge specifications to the gauge generator 30, which may facilitate constructing gauge-rendering data for rendering gauges for display via the first browser 14. The user may have configured a specific dashboard webpage to illustrate certain gauges, such as a gauge that indicates a bank account balance, a gauge that indicates how many Facebook messages the user has received, and so on, as discussed more fully below.

The user-specific dashboard webpage displayed via the first client browser 14 may provide various user options for adjusting or controlling dashboard functionality. For example, in one embodiment, the dashboard webpage provides options for creating new gauges, adjusting gauge configuration, applying different gauge skins, switching between gauge skins, adding new gauges, constructing new gauges, and so on. For example, a user may activate and run the server-side SDK 24, which is adapted to provide functionality for facilitating developing new gauges, such as via JavaScript® or other programming language. The SDK software 24 may be based upon an open-source programming platform.

After developing a specification for a new gauge, the new gauge may be installed on the server 22. The installed gauge may be stored in the gauge repository 32. The gauge generator 30 may include code for selectively retrieving gauge code from the gauge repository 32; referencing associated gauge configuration information via the gauge configuration module 34; referencing any applied user interface specifications 36; and generating code for one or more gauges to be used by the dashboard user interface code 22 to facilitate providing code for rendering (e.g., via the first browser 14) the user specific webpage illustrating the newly developed gauge.

Note that the website 20, which may be rendered via the browsers 12, 16, may include one or more gauge wizards to facilitate configuring, modifying, or creating gauges. The gauge wizard may be implemented as part of the SDK 24. Note that various modules 24-36 of the website 20 may be implemented via Common Gateway Interface (CGI) programming methods and/or via other suitable methods. Those skilled in the art with access to the present teachings may readily implement various modules of the website 20 and client computers 12, 16 without undue experimentation.

In the present example operative scenario, after installation of a new gauge or after changing or adjusting gauge configuration data or after applying a user interface skin, the user interface code 22 provides updated dashboard webpage rendering information to the first browser 14. The first browser 14 then displays the updated user-specific dashboard webpage.

The user-specific dashboard webpage, which is displayed via the first browser 14, may provide additional user options, e.g., for applying new skins to the dashboard webpage. A user interface skin may specify a predefined set of gauges and associated content and appearances. Alternatively, the skin merely includes code specifying a particular look and feel to be applied to the rendered dashboard webpage.

A particular gauge displayed via the first browser 12 may reference content 38 that is not stored on the server 22. For example, a gauge may display a bank account balance, a video feed from a webcam, and so on. The external content 38 may be retrieved via the website 20, e.g., dashboard user interface code 22, and then rendered via the first browser 14.

In the present example operative scenario, the user of the first computer 12 activates a webpage user option for configuring a particular gauge to be shared by others. In this case, the user supplies gauge configuration information for a particular gauge indicating that the gauge or particular contents thereof should be shared with the user of the second computer 16. Accordingly, when a user of the second client computer 16 accesses the dashboard website 20 and searches for gauges among the stored gauges 32, the shared gauge offered by the user of the first client computer 12 may be appear as available to the user of the second client computer 16 for server-side activation and display via the second browser 18.

In an alternative sharing scenario, the user of the first computer 12 posts an icon pertaining to a particular gauge to a website, such as Facebook. When other users select the posted icon, options for the other users to display the gauge associated with the posted icon on their computers may appear. Such functionality may be facilitated by a Facebook application that is adapted to communicate with the website 20 and access shared gauge information associated with the posted icon. The shared gauge information may be stored on and selectively retrieved from the stored gauge repository 32. Those skilled in the art with access to the present teachings may readily implement such functionality and develop appropriate Facebook applications without undue experimentation.

In another example sharing scenario, the user of the first computer 12 selects an option from the user specific dashboard webpage to share the entire dashboard configuration, including any applied skins, configured gauges, and so on, with other users. In this case, other users of the dashboard website 20 may be provided with options for activating a dashboard of another user, e.g., as a skin offered by the user of the first computer 12. Such shared user dashboard information may be maintained via the database 26 and then selectively accessed and activated by other users, such as in response to searches by other users performed via the second browser 18 and facilitated by the dashboard user interface code 22.

Note that additional user options may be provided via the website 20 and accompanying rendered pages. For example, an option to log into the website 20 as an administrator and to specify and configure dashboards to be used, for example, by members of a particular enterprise team (e.g., sales team) who are working on a particular project, may be provided.

In the present example embodiment, the user specific webpages displayed via the browsers 14, 18 may display browsed content in addition to gauges and accompanying content. For example, a user may employ the browser 14 to browse, i.e., navigate the network 40 and display various content, e.g., website content, while various gauges simultaneously appear in a display screen of the browser 14. The browsed content is displayed in so-called windshield portions of the display areas of the browsers 14, 18.

Page: 11

For the purposes of the present discussion, browsed content may be any data, information, graphical features, and so on, which may be accessible via data navigation. Examples of browsed content include webpages, database tables, and so on. Data navigation may refer to a transition of a graphical user interface display from a first display of one or more objects to a second display of one or more objects in response to user selection of an object or control in the first display of one or more objects. A user is said to navigate data if the user selects one or more different displayed objects, e.g., links, to activate other objects, e.g., website content, to be displayed. Data navigating behavior of a user may be any tendency of a user to perform one or more particular navigations or sequences of navigations.

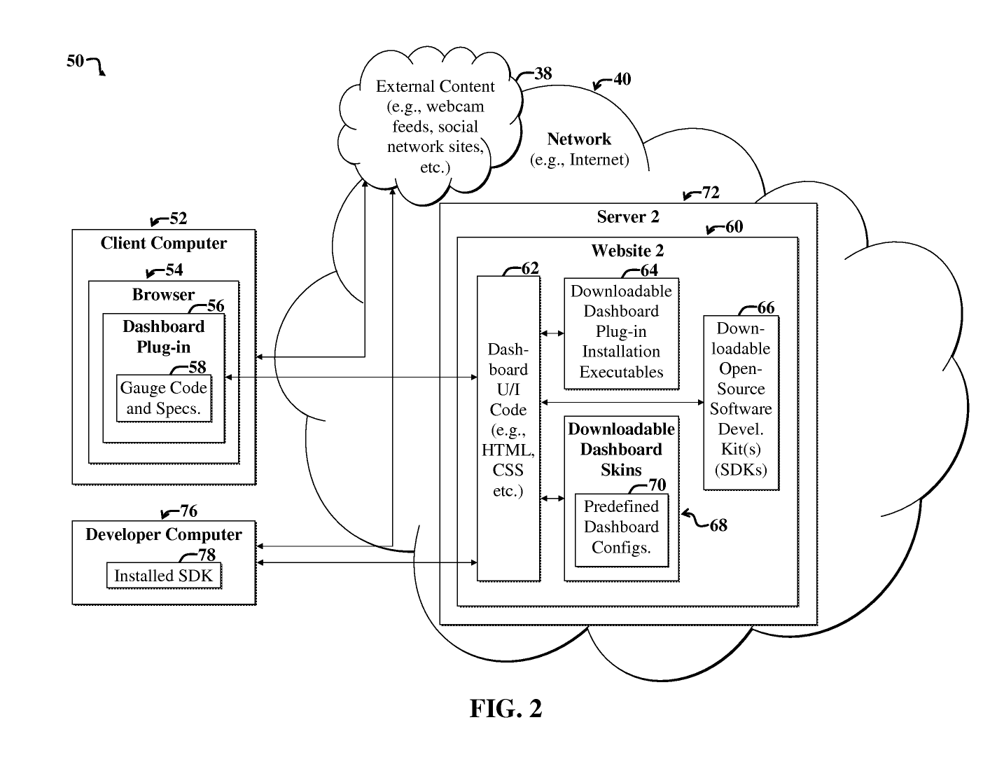

FIG. 2 is a diagram illustrating a second example embodiment of a dashboard browsing system 50 implemented via a client-side architecture. The dashboard system 50 and accompanying dashboard functionality is said to be implemented client-side as opposed to server-side, since computer code for generating and rendering gauges, dashboard skins, developing dashboards and gauges, and so on, is implemented on a client computer 52 as opposed to a server 72.

The system 50 includes the client computer 52 in communication with a second dashboard server 72 via the network 40. The second server 72 hosts a second dashboard website 60, which includes a second instance of dashboard user interface code 62 in communication with downloadable dashboard plugin installation executable files 64, a downloadable open-source SDK 66, and downloadable dashboard skins 68. The downloadable dashboard skins 68 include specifications for predefined dashboard configurations 70.

The client computer 52 includes a browser 54 with an installed dashboard plugin 56. The plugin 56 includes computer code 58 (i.e., gauge code and specifications) for constructing, rendering, and/or configuring gauges, skins, and/or other features of a dashboard to be displayed via the browser 54.

An example developer computer 76 is shown with an installed SDK 78, which has been downloaded from the second website 60 and installed on the developer computer 76. Note that the installed SDK 78 could also be installed on the client computer 52, and a browser and dashboard plugin could be installed on the developer computer 76, without departing from the scope of the present teachings.

In an example operative scenario, a user of the client computer 52 employs the browser 54 to browse, i.e., navigate, content, e.g., the external content 38, and content provided by the second website 60, via the network 40. When navigating the network 40, the dashboard plugin 56 causes the browser 54 to display navigated content in combination with gauges. The gauges may display metrics and/or other content (e.g., links, video feeds, etc.) according the configuration of each gauge, as discussed more fully below.

The dashboard plugin 56 may facilitate providing user options, via the browser 54, to adjust gauge configurations, scrolling paths, appearance frequencies, shared properties, and so on. Those skilled in the art with access to the present teachings may readily implement dashboard plugins and SDK's to meet the needs of a given implementation without undue experimentation.

The user of the client computer 52 may employ the browser 54 to navigate to the second website 60 to download the dashboard plugin 56, e.g., from the downloadable dashboard plugin installation executables 64. Once downloaded, the dashboard plugin 56 can be installed on the client computer 52. The users of the computers 52, 76 may also download a dashboard SDK from the second dashboard website 60 and accompanying downloadable open-source SDK(s) 66. The users of the computers 52, 76 may also download and install previously developed and uploaded dashboard skins via the second website 60 and accompanying downloadable dashboard skins 68.

The user of the example developer computer 76 may employ the installed SDK 78 to develop dashboards, which may be uploaded to the second website 60 and stored among the downloadable dashboard skins 68 to enable other users to search for and download the skins via the second website 60 and accompanying dashboard U/I code 62. Note that a developer, e.g., a user of the developer computer 76, may make dashboards available via websites other than the second dashboard website 60, without departing from the scope of the present teachings. Furthermore, certain SDK functionality may be incorporated into the dashboard plugin 56 to provide user options to activate wizards to develop, configure, change, and add dashboard features, such as gauges and associated gauge behaviors, appearances, and content linked thereto.

Note that various modules and components discussed with reference to FIGS. 1 and 2 may be combined or distributed among computing resources of a network other than or in addition to what has been shown and discussed. In addition, various features and functionality may be added. For example, the downloadable SDKs 66 may be incorporated entirely in the downloadable dashboard plugin installation executables 64, which may be stored via a database running on the server 72. Furthermore, one or more external websites 38 may accommodate one or more of the modules or components of the websites 20, 60. For example, a user may post an icon to an external website, where the icon is linked to the second website 60, such that user selection of the icon triggers user options to download and install particular dashboards and/or skins.

Note that whether dashboards are implemented entirely as skins or vice versa may be implementation specific and may vary depending upon the needs of a particular implementation. Those skilled in the art with access to the present teachings may readily determine and implement appropriate functionality to meet the needs of a given implementation, without undue experimentation.

Hence, with reference to FIGS. 1 and 2, embodiments may be implemented substantially client-side, server-side, or a combination of both. In a client-side implementation, developers may construct a website that acts as a landing page that includes profiles and settings for users to configure their dashboards. In a server-side implementation, a browser may be augmented with a dashboard plugin, or a new browser may be developed to enable content to be pulled or pushed to the browser.

Hence, certain embodiments may provide an Internet user with the ability to stream video, display pictures, and monitor emails, chats, Facebook, and multiple other Internet mediums by configuring a window dashboard into the Internet that has configurable gauges that allow the user to configure real time view into other Internet domains.

Browser-displayed dashboards may idealize or be modeled after a dashboard in a car, yacht, fighter cockpit, where the dashboard windshield is used to view data, and where gauges may facilitate monitoring transactions, metrics, and so on, which have been enabled for display via gauges.

Once a dashboard has been configured, data may be pushed to or pulled to gauges while the user is querying, viewing, or otherwise navigating various Internet (or other network) content.

Dashboard sharing options may allow users to share gauges, and may allow for outside third parties to supply gauges or dashboard main consoles to a dashboard site domain administrator or repository. Users viewing shared gauges or consoles may simultaneously watch a given movie, video camera feed, Internet navigation sequence, and so on.

For example, a given user may log-in to external content 38, such as a live video feed from a camera, video chat, streaming emails, weather, stock quotes, and so on, and make this content, or portions thereof, be available (to themselves and/or others) for viewing via a dashboard windshield and/or accompanying gauges.

A given dashboard may be configured to automatically selectively pull content from multiple websites for viewing via the dashboard. For example, a user could log into a server-side dashboard profile page associated with a dashboard website to view selected Internet sites related to their information preferences, e.g., personal, work, and or mixture of personal/work related information. Options for selectively making gauges disappear and reappear in a given dashboard may also be provided, as discussed more fully below.

Organizations, e.g., businesses, universities, governments, and so on, could register with a dashboard website and supply organization-specific dashboards and/or skins for promoting their interests.

Note that not all gauges need to be connected to the Internet. For example, certain gauges may enable users to complete, specify, or otherwise supply their own metrics (and associated values) for display via a gauge.

Furthermore, in certain implementations, an administrator of an enterprise network, for example, could configure groups of dashboards for individuals and groups thereof that monitor a given primary dashboard or gauge thereof. Group dashboards may be configured to enable multiple users use the same dashboard and gauges to monitor, for example, network traffic related to a particular work function.

Furthermore, gauges and/or dashboards of different users may be selectively linked and shared to facilitate collaboration and information exchange.

Key performance metrics could be set by an individual, a group of individuals, a dashboard administrator, and so on. Furthermore, gauges may be configured to act as alarms to issue alerts when predetermined conditions are met, e.g., when a particular metric passes a particular threshold.

For the purposes of the present discussion, a metric may be any measurement, parameter, or other indicator associated with a person or thing. Examples of metrics include numbers indicating bank account balances, credit card balances, goal-completion status, outside temperature, number of new emails received, and so on.

Hence, implementations of various embodiments discussed herein may vary substantially without departing from the scope of the present teachings.

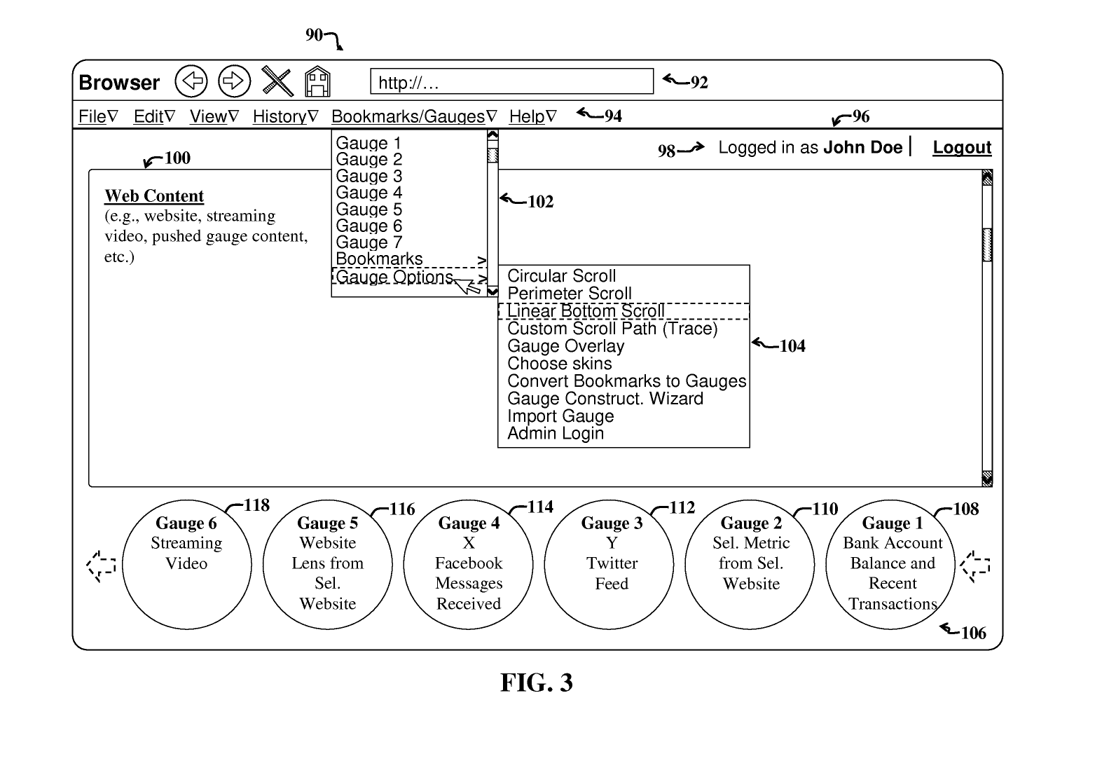

FIG. 3 is a diagram illustrating a first example user interface display screen 90, which may be generated by the systems 10, 50 of FIGS. 1 and/or 2, whereby a user can configure one or more translating gauges. For the purposes of the present discussion, a gauge is said to translate or scroll if it moves across a display screen or otherwise periodically appears and disappears within the display screen. However, note that translating or scrolling gauges need not disappear or reappear within a given display screen. For example, gauges may circulate about a closed path within a display screen, where all of the implemented gauges remain visible in the display screen. However, use of large numbers of gauges may necessitate that some gauges periodically disappear from the display screen for a predetermined amount of time.

The example display screen 90 represents an example browser display screen that illustrates an example dashboard 96. The browser display screen 90 includes a navigation bar 92 with user interface controls (e.g., fields and buttons) for navigating a network, such as by entering Uniform Resource Locators (URLs). A menu bar 94 includes various drop-down menus for facilitating accessing browser, plug-in, and/or website functionality.

In the present example embodiment, the menu bar 94 includes a bookmarks/gauges drop-down menu 102, which provides an optional way to select gauges, bookmarks, and gauge options. Note that various gauges 106 may be selected individually, e.g., by moving a mouse over one of the gauges 106 and selecting the gauge.

The example drop-down menu 102 is shown including a gauge-options sub-menu 104, which illustrates various example user options for configuring the gauges 106. In the present example embodiment, the gauges 106 are displayed below a first screen section 100. The first screen section 100, also called the windshield, is adapted to display navigated content, such as websites, streaming video, content selectively pushed from a gauge to the windshield 100, and so on.

For the purposes of the present discussion, content is said to be pulled to a display screen or gauge if the content is downloaded from a server or otherwise configured to appear via a client user interface, such as a browser, at a specified time or times. For example, if a user configures the user interface gauge 110 to display sports scores via a gauge every Friday at noon, then subsequently appearing sports scores are said to be pulled to the gauge 110. If the gauge 110 then triggers display of the pulled content in a different window or display region, the content appearing in the different window or display region is said to be pushed to the different window or display region via the gauge.

In the present example embodiment, the gauges 106 have been configured to scroll across the display screen 90 from to left to right at the bottom of the screen 90, below the windshield 100. The example gauges 106 include a first gauge 108, which is adapted to graphically depict a user-specified bank account balance; the second gauge 110, which is adapted to graphically depict a particular metric, e.g., outside weather temperature, from a given website; a third gauge 112, which is adapted to display a selected Twitter feed; a fourth gauge 114, which is adapted to indicate a number of new Facebook messages received by the user and to enable access to the new messages and the Facebook website; a fifth gauge 116, which acts as a movable lens or window into a selected website, whereby selecting and dragging the lens 116 may reveal content of the selected website as though the selected website were positioned behind the display screen 90; and a sixth gauge 118, which is adapted to display a user selected video stream.

Note that the various gauges 106 may be linked to external websites, such that the gauges 106 implement bookmark functionality. For the purposes of the present discussion, bookmark functionality of a user interface may be any set of one or more functions for enabling a user to transition to a website or other predetermined content upon selection of a user interface control, such as a link, wherein the user interface control may be readily adjusted by a user of the user interface. Such a user interface control is called a bookmark.

Note that in certain browser implementations, the scrolling gauges 106 may replace and/or augment bookmarks, tabs, and windows. For example, gauges may be replaced with scrolling tabs in certain implementations, without departing from the scope of the present teachings.

The example sub-menu 104 includes user options for configuring the gauges 106, including gauge behavior. For example, the sub-menu 104 includes a user option to specify a circular scroll path for the gauges 106; a user option to cause the gauges 106 to circulate about the perimeter of the display screen 90; a user option to cause the gauges 106 to scroll along the bottom of the display screen 90 as shown; a user option to cause the gauges 106 to overlay on the windshield 100; a user option to choose from a set of predetermined dashboard skins and to install particular skins; a user option to facilitate converting any bookmarks appearing in the drop-down menu 102 to gauges; a user option to activate a gauge construction wizard to facilitate developing or inserting new gauges in the dashboard 96; a user option to import a particular gauge; and a user option to log-in to the dashboard 96 as an administrator. Note that the user is currently logged into the dashboard 96 as John Doe, as indicated in a login information section 98.

Note that the drop-down menu and accompanying sub-menu 104 may include additional or fewer options than those shown, without departing from the scope of the present teachings. For example, the administrator login option of the sub-menu 104 may be provided in a different menu, such as a file menu of the menu bar 94. In addition, the gauges 106 are merely illustrative and may vary substantially among different dashboards.

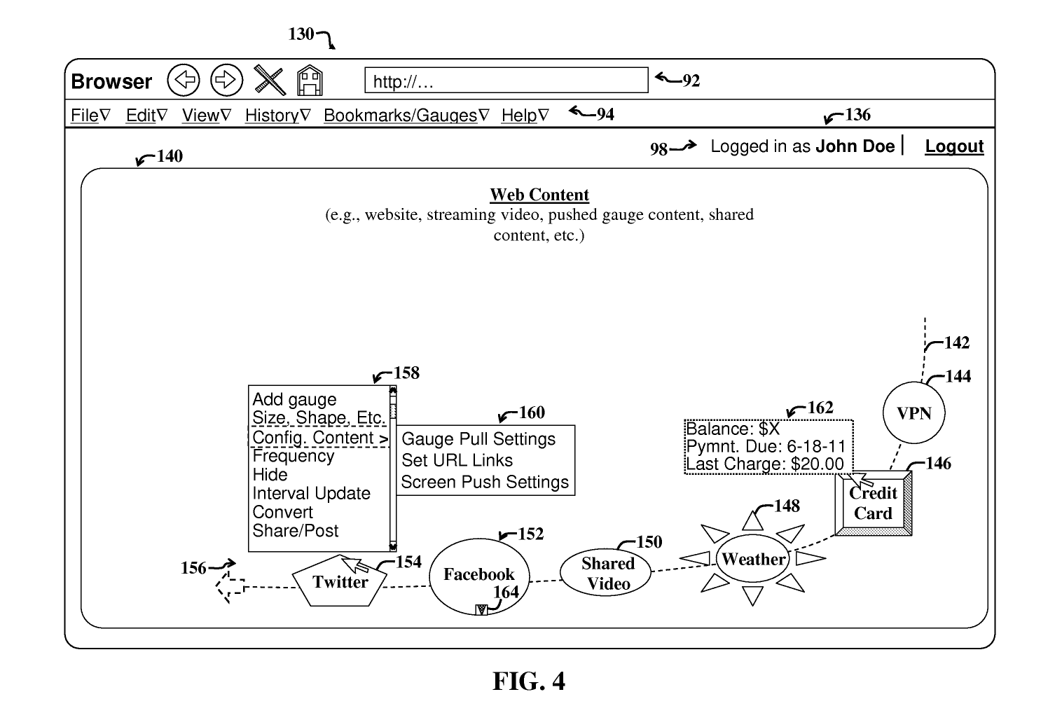

FIG. 4 is a diagram illustrating a second example user interface display screen 130 after an example skin has been applied to the user interface display screen 90 of FIG. 3. Alternatively, the second user interface display screen 130 may be derived from the user interface display screen 90 after manual reconfiguration thereof via various configuration options.

A newly configured or skinned dashboard 136 and accompanying windshield 140 appears with a new set of gauges 156, which are overlaid on the second windshield 140 and configured to scroll along an arc path 142 along the lower right portion of the second windshield 140. The new set of gauges 156 have been shrunk (relative to the gauges 106 of FIG. 3), and different gauge graphics have been employed.

The gauge path 142 may have been set or adjusted in response to selection of a custom scroll path (trace) user option from the sub-menu 104 of FIG. 3. Activation of the custom scroll path user option may trigger additional functionality for enabling a user to specify a path, such as the arched path 142 along which the gauges 156 scroll when moving across the windshield 140. After selection of the custom scroll path user option, a user may drag a mouse cursor across the windshield 140 in a desired gauge scroll path, thereby specifying where a particular sequence of gauges terminates, beyond where gauges of the sequence of gauges disappear from the windshield 140 for a predetermined time interval and reappear at a start of the scrolling sequence of gauges after the predetermined time interval. The time interval that determines the appearance and disappearance frequencies of a particular gauge may be determined based on various factors, including the length of the path 142, the sizes of the gauges 156, and any appearance frequencies set by a user.

The example gauges 156 include a Virtual Private Network (VPN) gauge 144, which may trigger user access to a specified VPN upon selection of the VPN gauge 144 and display of VPN content via the windshield 140. A credit card gauge 146 has been configured so that a mouse-over of the credit card gauge 146 results in display of a hover layer 162. The example hover layer 162 illustrates an account balance, a due date, and an amount of a most recent charge made via a credit card and linked account associated with the credit card gauge 146.

User selection of the credit card gauge 146, such as by right-clicking of the gauge 146 (via a computer mouse), may cause a website associated with a user's credit card to appear in the windshield 140. The credit card gauge 146 may be configured with username and password information, such that user selection of the credit card gauge 146 causes an automatic user log-in to the associated credit card account website, which then appears in the windshield 140. The credit card account username and password information may also be used by the credit card gauge 146 to selectively retrieve information for populating the hover layer 162. Similar username and password mechanisms may be employed to facilitate logging into other types of accounts (other than a credit card account), such as a Facebook account, Twitter account, and so on.

In general, each of the gauges 156 may include a particular hover-layer, drop-down feature, or other mechanism for displaying gauge content, such as metrics. In certain implementations, hover layer functionality may automatically be implemented when a size of a gauge is reduced below predetermined threshold dimensions.

The example gauges 156 further include a weather gauge 148, for displaying or linking to weather content; a shared video gauge 150 for displaying or linking to a shared video source; a Facebook gauge 152 for displaying content from or linking to a Facebook account; and a Twitter gauge 154 for displaying content from or linking to a Twitter account.

In the present example embodiment, the shared video gauge 150 has been shared by posting associated gauge code to a Facebook account for download and implementation by other persons with access to viewing the user's Facebook account. Alternatively, the shared video gauge 150 has been uploaded or downloaded from the second website 60 of FIG. 2 or from another website, e.g., Facebook page.

The example Facebook gauge 152 has been configured to show a drop-down control 164. Selection of the drop-down control 164 may trigger display additional information associated with the Facebook gauge 152, such as the number of new or unread Facebook messages received, and so on.

Various additional user options for configuring gauges and associated behaviors may be provided via additional menus, which may appear, for example, in response to right-clicking (e.g., via a computer mouse) of a particular gauge. For example, an example right-click menu 158 appears in response to a user right-clicking the twitter gauge 154.

The right-click menu 158 provides example user options for adding a gauge, adjusting gauge appearance (size, shape, etc.), configuring gauge content, setting gauge appearance frequencies, hiding a gauge, specifying a time interval at which to update a gauge, converting a gauge to a bookmark or other user interface control, and for sharing or posting a gauge to enable access by other users. An example fly-out menu 160 from the right-click menu 158 appears when the user selects the user option from the right-click menu 158 to configure a gauge. The fly-out menu 160 includes additional user options for adjusting how or when a gauge pulls content from a website; for setting or adjusting any Uniform Resource Locator (URL) or other links associated with the Twitter gauge 154; and for adjusting how or when the Twitter gauge 154 pushes Twitter content to the windshield 140. For example, selection of the screen push settings user option from the fly-out menu 160 may activate functionality for enabling a user to cause the windshield 140 to display the user's Twitter page at a particular time.

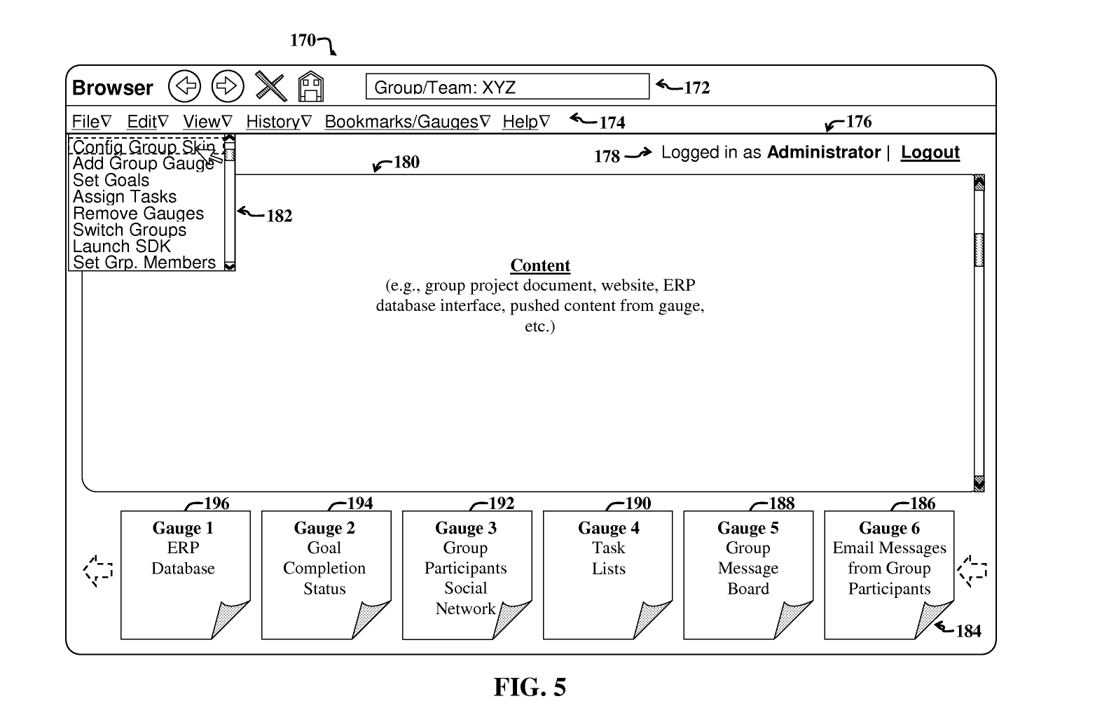

FIG. 5 is a diagram illustrating a third example user interface display screen 170, which may be accessible via the example user interface display screens 90, 130 of FIGS. 2 and 3. The third example user interface display screen 170 may appear after a user has logged into a dashboard system as an administrator, as indicated in a login section 178. A user may login to a dashboard as an administrator, such as by selecting the administrator login user option from the sub-menu 104 of FIG. 3, and after entering sufficient predetermined administrator login credentials, e.g., administrator username and password.

A resulting example administrator dashboard 176 appears. For illustrative purposes, the dashboard 176 is adapted for use with a corporate network and associated Enterprise Resource Planning (ERP) system. Content displayed in an associated windshield 180 may include content pertaining to a particular group project, database, and so on, associated with an enterprise team that the administrator oversees.

An example set of ERP-related gauges 184 are configured to scroll laterally across a bottom of the third example user interface display screen 170. The example ERP-related gauges 184 may reference content residing on an ERP system and/or accompanying network.

The example gauges 184 include an email gauge 186 for monitoring and accessing email messages from participants or members of a particular enterprise team (e.g., sales team, engineering team, etc.). A message-board gauge 188 facilitates accessing contents or other information pertaining to a group message board used by the enterprise team. A task-lists gauge 190 facilitates accessing contents and completion status information pertaining to a task list associated with each member of the enterprise team. A social-network gauge 192 provides information pertaining to or linking to social networks associated with each enterprise team member. A goal-completion-status gauge 194 facilitates viewing information pertaining to team goals and completion status. An ERP-database gauge 196 facilitates accessing predetermined content from one or more ERP applications.

An example file menu 182 includes user options for configuring a group skin or dashboard; for adding a group gauge; for setting group goals; for assigning tasks to a group and/or members thereof; for removing gauges from a group dashboard or skin; for switching the administrator dashboard view 176 to a different dashboard to enable configuration thereof and adjustment thereto; a user option to launch an SDK or wizard to facilitate constructing a gauge, skin, and/or dashboard for a particular group, e.g., enterprise team; and to set or adjust team members of a particular group (also called team herein).

In the present example embodiment, the administrator has selected an option from the drop-down file menu 182 to configure the dashboard as a group dashboard. A configured group dashboard may be downloaded and installed (e.g., in a client-side implementation) or otherwise activated (e.g., in a server-side implementation) by members of a particular group as a group skin.

Note that the file menus 174 and accompanying user options of FIGS. 3-5 may be implemented in part via a browser plugin, or alternatively (or in addition), via a webpage or other network page.

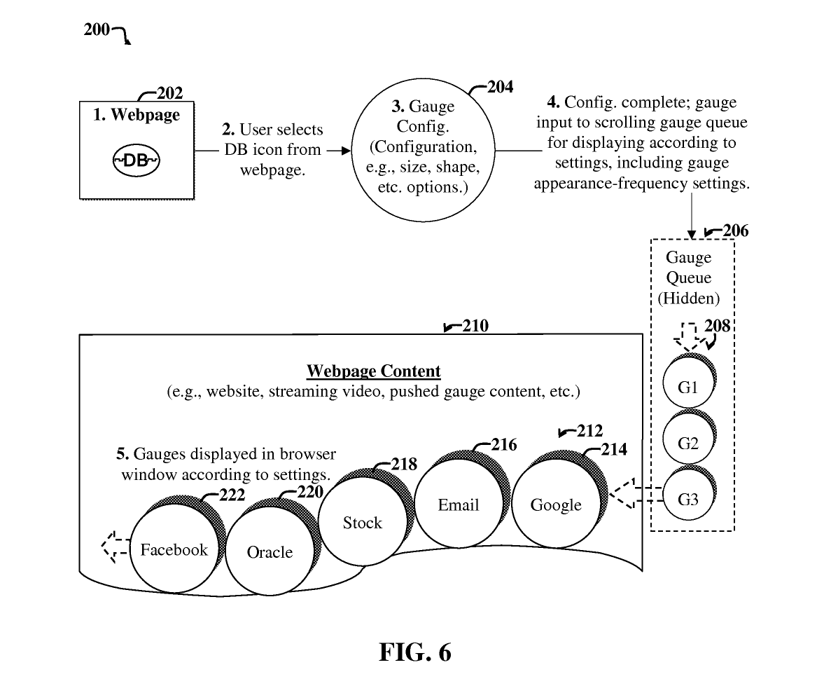

FIG. 6 is a flow diagram illustrating a first example process 200, which may be implemented via the systems 10, 50 of FIGS. 1 and/or 2, for adding a gauge to a user interface display screen of a browser.

The first example process includes a user browsing to a webpage 202 and then selecting a dashboard gauge icon (DB) that has been posted to the webpage. After user selection of the DB icon, user gauge configuration options appear 204 to enable a user to configure, for example, gauge size, shape, scrolling properties (e.g., paths and scroll rates), appearance-frequencies, and so on.

After the gauge has been configured, and configuration options have been selected, the gauge is input to a queue 206, which holds gauges 208 (G1-G3) off screen, and selectively scrolls gauges 212 across a user interface screen 210 of a user's browser in accordance with pre-selected gauge appearance-frequency settings and scrolling behaviors and paths.

The example gauges 212 include a Google gauge 214, an email gauge 216, a stock gauge 218, an Oracle gauge 220, and a Facebook gauge 222. The gauges 212 may act as bookmarks such that user selection of the gauges 212 may trigger display of websites linked to the gauges 212 in the browser display screen 210. Additional gauge information may be displayed via hover layers.

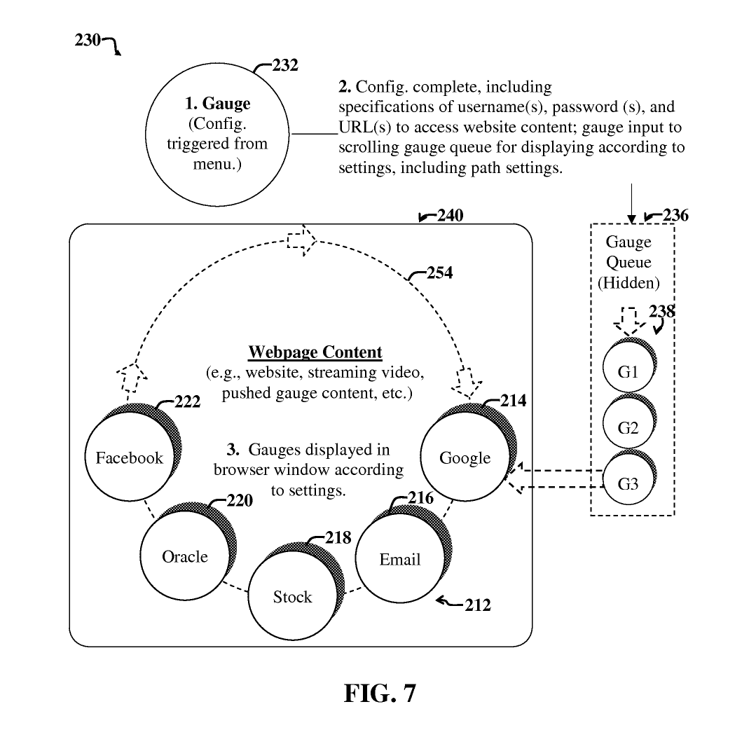

FIG. 7 is a flow diagram illustrating a second example process 230, which may be implemented via the systems 10, 50 of FIGS. 1 and/or 2, for adding a gauge to a user interface display screen 240 of a browser.

The process 230 involves a user selecting a gauge-configuration option 232, such as from a dashboard menu generated by a dashboard plugin or dashboard website. After configuration of a gauge, which may include supplying username and password information for a website linked to a gauge, the gauge is input to or otherwise loaded in a gauge queue 236. Queued gauges 238 may remain hidden for predetermined time intervals until they are scrolled onto the browser display screen 240.

In the present example implementation, the various gauges 212 have been configured to circulate in a closed circular path 254 within the browser display screen 240.

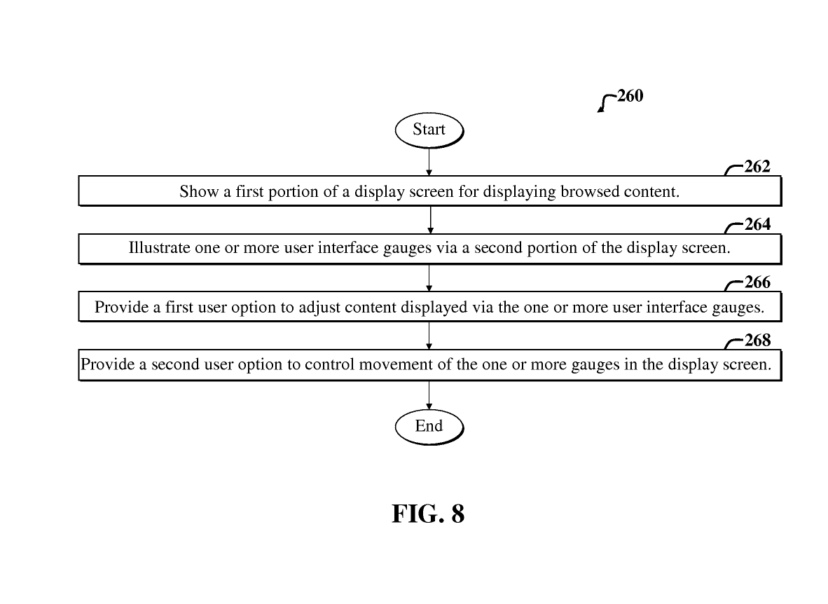

FIG. 8 is a flow diagram of a first example method 260 adapted for use with the embodiments 10, 50, 90, 130, 170 of FIGS. 1-5. The first example method 260 includes a first step 262, which involves showing a first portion of a display screen (e.g., windshield) for displaying browsed content, which may include any data, information, graphical features, and so on, which may be accessible via data navigation, such as Internet browsing.

A second step 264 includes illustrating one or more user interface gauges via a second portion of the display screen. The second portion of the display screen may include portions of the display screen occupied by the gauges themselves and overlaid upon the first portion of the display screen. Alternatively, the second portion of the display screen may be separate from the first portion of the display screen.

A third step 266 includes providing a first user option to adjust content displayed via the one or more user interface gauges.

A fourth step 268 includes providing a second user option to control movement of the one or more gauges across the display screen, such as across the first portion and/or across a separate second portion of the display screen.

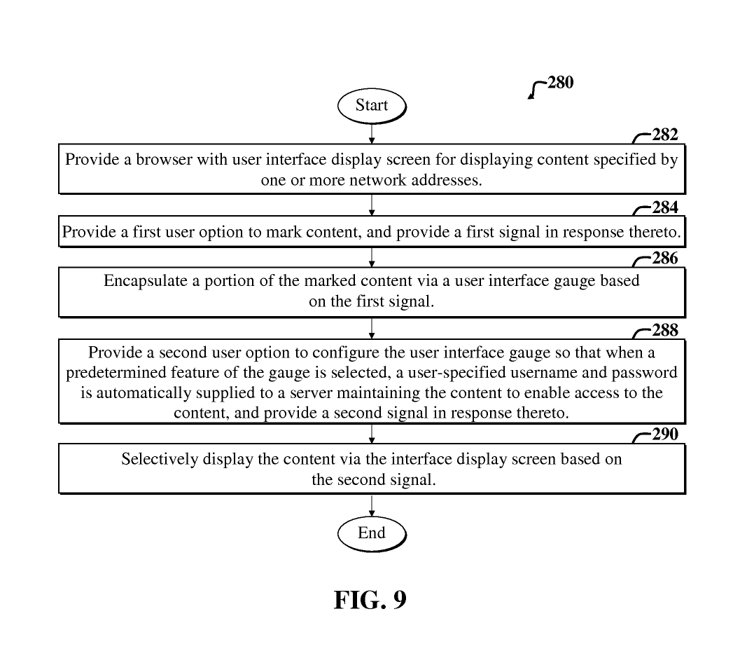

FIG. 9 is a flow diagram of a second example method 280 adapted for use with the embodiments 10, 50, 90, 130, 170 of FIGS. 1-5. The second example method 280 includes an initial browsing step 282, which includes providing a browser with user interface display screen for displaying content specified by one or more network addresses.

A subsequent content-marking step 284 includes providing a first user option to mark content, and providing a first signal in response thereto.

Next, a gauge-forming step 286 includes encapsulating a portion of the marked content via a user interface gauge based on the first signal.

Subsequently, a configuring step 288 includes providing a second user option to configure the user interface gauge so that when a predetermined feature of the gauge is selected, a user-specified username and password is automatically supplied to a server, which maintains the content, to enable user access to the content, and providing a second signal in response thereto.

Next, a displaying step 290 includes selectively displaying the content via the interface display screen in response to the second signal.

Note that the methods 260, 280 of FIGS. 8 and 9 may be altered without departing from the scope of the present teachings. For example, various steps may be rearranged, certain steps may be omitted, and additional steps may be added.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating access to data, the method comprising:
showing a first portion of a display screen for displaying browsed content;
illustrating one or more user interface gauges via a second portion of the display screen;
providing a first user option to adjust content displayed via the one or more user interface gauges; and
providing a second user option to control movement of the one or more gauges across the display screen.

2. The method of claim 1, wherein movement of the one or more gauges include a scrolling motion along a predetermined path.

3. The method of claim 2, further including providing a user interface control adapted to enable a user to specify a path along which gauges follow when moving across the display screen.

4. The method of claim 3, further including providing one or more user interface controls adapted to enable a user to specify where a scrolling sequence of gauges terminates, beyond where gauges of the sequence of gauges disappear from the display screen for a predetermined time interval and reappear at a start of the scrolling sequence of gauges after the predetermined time interval.

5. The method of claim 1, further including providing one or more user interface controls adapted to enable a user to adjust a frequency at which a particular gauge appears in the display screen.

6. The method of claim 1, further including providing one or more user interface controls adapted to enable a user to affect content to be displayed via each of the one or more gauges.

7. The method of claim 1, further including providing a third user option to add one or more gauges to be displayed via the display screen and to select or adjust content to be displayed therein.

8. The method of claim 7, wherein the content includes streaming video data from a user selected website.

9. The method of claim 7, wherein the content includes a measurement of a metric derived from a user specified website.

10. The method of claim 9, wherein the metric includes an indication of a number of messages received by a user via an account of the user.

11. The method of claim 9, wherein the metric includes a bank or credit card account balance.

12. The method of claim 1, further including providing a fourth user option to activate a user interface skin that adjusts the display screen in accordance with computer code associated with the user interface skin.

13. The method of claim 12, wherein the user interface skin includes one or more gauges with one or more predefined characteristics.

14. The method of claim 13, wherein the one or more predefined characteristics include gauge shapes, sizes, and hyperlinks characterizing each gauge.

15. The method of claim 1, further including providing a fifth user option to share a gauge with another user of the method.

16. The method of claim 15, further including providing one or more user interface controls to facilitate posting a shared gauge to a predetermined website.

17. The method of claim 1, further including providing a sixth user option to specify content or a link thereto to be pulled to a particular gauge at a predetermined time.

18. The method of claim 1, further including providing a seventh user option to select or configure content to be pulled or pushed to the first portion of the display screen at one or more predetermined times.

19. An apparatus comprising:
a digital processor coupled to a display and to a processor-readable storage device, wherein the processor-readable storage device includes one or more instructions executable by the digital processor to perform the following acts:
showing a first portion of a display screen for displaying browsed content;
illustrating one or more user interface gauges via a second portion of the display screen;
providing a first user option to adjust content displayed via the one or more user interface gauges; and
providing a second user option to control movement of the one or more gauges across the display screen.

20. A processor-readable storage device including instructions executable by a digital processor for modifying a workplace decision-making hierarchy, the processor-readable storage device including one or more instructions for:
showing a first portion of a display screen for displaying browsed content;
illustrating one or more user interface gauges via a second portion of the display screen;
providing a first user option to adjust content displayed via the one or more user interface gauges; and
providing a second user option to control movement of the one or more gauges across the display screen.
